(19) United States
(12) Patent Application Publication
(10) Pub. No.: US 2021/0147673 A1
(43) Pub. Date: May 20, 2021

(54) FULL BIODEGRADABLE HIGH-BARRIER MULTI-LAYER COMPOSITE MATERIAL AND PREPARATION METHOD THEREOF AS WELL AS PACKAGING BAG

(71) Applicant: Qingdao Fullsun Biotechnology Co., Ltd, Qingdao (CN)

(72) Inventor: Dong Yang, Qingdao (CN)

(73) Assignee: Qingdao Fullsun Biotechnology Co., Ltd

(21) Appl. No.: 17/159,186

(22) Filed: Jan. 27, 2021

(30) Foreign Application Priority Data
Jan. 13, 2021 (CN) 2021100404965

(51) Int. Cl. C08L 67/04; C08L 67/02; B32B 27/36; B32B 38/00; B32B 37/12; B32B 27/30; B32B 27/08; B32B 1/00; B65D 33/25; B65D 65/40; B65D 65/46

(52) U.S. Cl. CPC C08L 67/04; B32B 2333/04; B32B 27/36; B32B 38/0012; B32B 37/12; B32B 27/306; B32B 27/08; B32B 1/00; B65D 33/2508; B65D 65/40; B65D 65/466; C08L 2205/035; B32B 2307/518; B32B 2439/46; B32B 2307/7163; B32B 2038/0028; B32B 2307/7244; B32B 2329/04; B32B 2367/00; C08L 67/02

(57) ABSTRACT

The present disclosure is appropriate for the technical field of packaging bag materials, and provides a full biodegradable high-barrier multi-layer composite material and a preparation method thereof as well as a packaging bag. The full biodegradable high-barrier multi-layer composite material comprises the following components: polylactic acid, terephthalic acid-adipic acid-butanediol copolyester, polyvinyl alcohol, polyurethane glue and starch carrageenan. Embodiments of the present disclosure provide the full biodegradable high-barrier multi-layer composite material which is obtained by using the terephthalic acid-adipic acid-butanediol copolyester as a degradable layer, using polyvinyl alcohol as a barrier layer and by composing the degradable layer with the barrier layer via polyurethane glue and starch carrageenan. Through the present disclosure, the problems, such as high oxygen permeation rate, poor barrier property and poor preservation degree, in the existing degraded film can be solved.

### TECHNICAL FIELD

The present disclosure belongs to the technical field of packaging bag materials, and particularly to a full biodegradable high-barrier multi-layer composite material and a preparation method thereof as well as a packaging bag.

### BACKGROUND

At present, pollutions of plastic wastes visible in our's life environment at anytime on environment mainly include plastic bags and plastic products. This plastic garbage cannot be degraded for 500 years in the natural environment, seriously harm human beings and animals and plants. In the face of the increasingly serious white pollution problem, people hope to find a plastic substitute that can replace the existing plastic properties and does not cause white pollution, and accordingly, degradable plastics are generated. This novel functional plastic has the characteristics that after the plastic is discarded when reaching a certain service life, it has some property loss and change in appearance under specific environmental conditions so as to be biodegraded, which does not harm natural environment.

Although the existing biodegradable plastic can be prepared into garbage bags, shopping bags and the like so as to reduce white plastic pollution, but it is only limited to meet daily life' use, and other complicated functional packaging bags cannot be realized by high-temperature digestion, low-temperature refrigeration, vacuum preservation and other packaging technologies. Furthermore, the existing biodegradable plastic also has the problems of high oxygen permeation rate, poor barrier property, poor preservation degree and the like.

### SUMMARY

The object of the present disclosure is to provide a full biodegradable high-barrier multi-layer composite material, aiming to solve the problems proposed in the background.

Embodiments in the present disclosure are realized as follows: a full biodegradable high-barrier multi-layer composite material, comprising the following components in parts by weight: 10˜50 parts of polylactic acid, 20˜100 parts of terephthalic acid-adipic acid-butanediol copolyester, 10˜50 parts of polyvinyl alcohol, 10˜50 parts of polyurethane glue and 10˜50 parts of starch carrageenan.

As a preferred embodiment of the present disclosure, the full biodegradable high-barrier multi-layer composite material comprises the following components in parts by weight: 20˜40 parts of polylactic acid, 80˜100 parts of terephthalic acid-adipic acid-butanediol copolyester, 20˜40 parts of polyvinyl alcohol, 20˜40 parts of polyurethane glue and 20˜40 parts of starch carrageenan.

As another preferred embodiment of the present disclosure, the polyurethane glue comprises an isocyanate prepolymer and polyester polyol.

As a preferred embodiment of the present disclosure, a mass ratio of isocyanate prepolymer to polyester polyol is 100: (70˜80).

As a preferred embodiment of the present disclosure, a mass ratio of starch glue to carrageenan in the starch carrageenan is (4˜6): (6˜4).

Another object of the present disclosure is to provide a preparation method of a full biodegradable high-barrier multi-layer composite material, comprising the following steps:

weighing polylactic acid, terephthalic acid-adipic acid-butanediol copolyester, polyvinyl alcohol, polyurethane glue and starch carrageenan according to the weight parts of the above components;

biaxially stretching polylactic acid to obtain a polylactic acid film;

preparing polyvinyl alcohol into a film to obtain a polyvinyl alcohol film;

mixing polyurethane glue with starch carrageenan to obtain waterborne composite glue;

coating the waterborne composite glue on the polyvinyl alcohol film to form a barrier layer;

preparing terephthalic acid-adipic acid-butanediol copolyester into a film to obtain a terephthalic acid-adipic acid-butanediol copolyester film; and

compositing the terephthalic acid-adipic acid-butanediol copolyester film with the polylactic acid film through the barrier layer, and then curing, so as to obtain the full biodegradable high-barrier multi-layer composite material.

Another object of the present disclosure is to provide a full biodegradable high-barrier multi-layer composite material prepared by the above preparation method.

As another preferred embodiment of the present disclosure, the oxygen permeation rate of the full biodegradable high-barrier multi-layer composite material is no more than 35 cc/m²/24 h/1 Pa/24° C.

Another object of the present disclosure is to provide a packaging bag, comprising a bag body and a zipper, wherein the bag body is made of the above full biodegradable high-barrier multi-layer composite material.

As another preferred embodiment of the present disclosure, the zipper comprises polylactic acid and terephthalic acid-adipic acid-butanediol copolyester, and a mass ratio of polylactic acid to terephthalic acid-adipic acid-butanediol copolyester in the zipper is (4˜6):(6˜4).

The full biodegradable high-barrier multi-layer composite material provided by the embodiments of the disclosure is obtained by using the terephthalic acid-adipic acid-butanediol copolyester as a degradable layer and using polyvinyl alcohol as a barrier layer and by composing the degradable layer with the barrier layer via polyurethane glue and starch carrageenan. Through the present disclosure, the existing problems, such as high oxygen permeation rate, poor barrier property and poor preservation degree, in the existing film can be solved. The components of the degradable layer can be biodegraded and contact with microorganisms and water under industrial composts, so as to generate carbon dioxide and water after being naturally degraded within 180 days, in this way, environmental pollution cannot be caused, white pollution is solved, and environment is protected. Therefore, the full biodegradable high-barrier multi-layer composite material provided by embodiments of the present disclosure can be widely applied to various industries, such as daily life, industrial packaging, food packaging and pharmaceutical packaging, thereby effectively solving the problems of composite packaging and the like. In addition, the starch carrageenan is modified by adding polyurethane glue so as to further improve the practicability of the starch carrageenan. The modified starch carrageenan has the advantages of rapid drying, firm adhesion, moisture resistance, corrosion prevention and mold prevention, natural environmental friendliness, enhanced degradation property and the like.

### DESCRIPTION OF THE EMBODIMENTS

Next, the technical solution of the present disclosure will be clearly and completely described in combination with embodiments of the disclosure. Obviously, the described embodiments are only a part of embodiments of the present disclosure but not all the embodiments. Based on the embodiments of the present disclosure, all other embodiments obtained by persons of ordinary skill in the art without creative efforts belong to the scope of protection of the present disclosure.

### Example 1

This example provides a full biodegradable high-barrier multi-layer composite material and a packaging bag, wherein a method for preparing the packaging bag comprises the following steps:

S1, 10 g of polylactic acid (PLA), 100 g of terephthalic acid-adipic acid-butanediol copolyester (PBAT), 10 g of polyvinyl alcohol (PVA), 10 g of polyurethane glue and 10 g of starch carrageenan were weighed; wherein, the polyurethane glue included an isocyanate prepolymer (A glue) and polyester polyol (B glue), a mass ratio of isocyanate prepolymer to polyester polyol was 100:70; a mass ratio of starch glue to carrageenan in the starch carrageenan was 4:6;

S2, the above weighed polylactic acid was biaxially stretched to obtain a polylactic acid film for later use;

S3, the above weighed polyvinyl alcohol was prepared into a film to obtain a polyvinyl alcohol film;

S4, polyurethane glue was sufficiently and evenly mixed with starch carrageenan to obtain waterborne composite glue;

S5, the above waterborne composite glue was coated on the polyvinyl alcohol film through the existing degradable high-barrier packaging coating equipment to form a barrier layer, wherein the coating densities of polyurethane glue and starch carrageenan were controlled to 1 g/m²;

S6, terephthalic acid-adipic acid-butanediol copolyester was prepared into a film and patterns were printed by a printing machine to obtain a terephthalic acid-adipic acid-butanediol copolyester film;

S7, the above terephthalic acid-adipic acid-butanediol copolyester film was composited with the polylactic acid film utilizing a solvent-free compositing machine through the barrier layer to form a degradable layer, then the degradable layer was cured for 72 h using a curing machine, and subsequently, the composition degree was inspected using an article test machine, so as to obtain the full biodegradable high-barrier multi-layer composite material; and

S8, polylactic acid and terephthalic acid-adipic acid-butanediol copolyester were mixed in a mass ratio of 6:4 and then prepared into a zipper; then the zipper and the above obtained full biodegradable high-barrier multi-layer composite material were made into a bag through a bag making machine, so as to obtain a packaging bag with a full biodegradable high-barrier multi-layer.

### Example 2

This example provides a full biodegradable high-barrier multi-layer composite material and a packaging bag, wherein a method for preparing the packaging bag comprises the following steps:

S1, 50 g of polylactic acid (PLA), 20 g of terephthalic acid-adipic acid-butanediol copolyester (PBAT), 50 g of polyvinyl alcohol (PVA), 50 g of polyurethane glue and 50 g of starch carrageenan were weighed; wherein, the polyurethane glue included an isocyanate prepolymer (A glue) and polyester polyol (B glue), a mass ratio of isocyanate prepolymer to polyester polyol was 100:80; a mass ratio of starch glue to carrageenan in the starch carrageenan was 6:4;

S2, the above weighed polylactic acid was biaxially stretched to obtain a polylactic acid film for later use;

S3, the above weighed polyvinyl alcohol was prepared into a film to obtain a polyvinyl alcohol film;

S4, polyurethane glue was sufficiently and evenly mixed with starch carrageenan to obtain waterborne composite glue;

S5, the above waterborne composite glue was coated on the polyvinyl alcohol film through the existing degradable high-barrier packaging coating equipment to form a barrier layer, wherein the coating densities of polyurethane glue and starch carrageenan were controlled to 5 g/m²;

S6, terephthalic acid-adipic acid-butanediol copolyester was prepared into a film and patterns were printed by a printing machine to obtain a terephthalic acid-adipic acid-butanediol copolyester film;

S7, the above terephthalic acid-adipic acid-butanediol copolyester film was composited with the polylactic acid film utilizing a solvent-free compositing machine through the barrier layer to form a degradable layer, then the degradable layer was cured for 72 h using a curing machine, and subsequently, the composition degree was inspected using an article test machine, so as to obtain the full biodegradable high-barrier multi-layer composite material; and

S8, polylactic acid and terephthalic acid-adipic acid-butanediol copolyester were mixed in a mass ratio of 4:6 and then prepared into a zipper; then the zipper and the above obtained full biodegradable high-barrier multi-layer composite material were made into a bag through a bag making machine, so as to obtain a packaging bag with a full biodegradable high-barrier multi-layer.

### Example 3

This example provides a full biodegradable high-barrier multi-layer composite material and a packaging bag, wherein a method for preparing the packaging bag comprises the following steps:

S1, 15 g of polylactic acid (PLA), 40 g of terephthalic acid-adipic acid-butanediol copolyester (PBAT), 15 g of polyvinyl alcohol (PVA), 15 g of polyurethane glue and 15 g of starch carrageenan were weighed; wherein, the polyurethane glue included an isocyanate prepolymer (A glue) and polyester polyol (B glue), a mass ratio of isocyanate prepolymer to polyester polyol was 100:70; a mass ratio of starch glue to carrageenan in the starch carrageenan was 5:5;

S2, the above weighed polylactic acid was biaxially stretched to obtain a polylactic acid film for later use;

S3, the above weighed polyvinyl alcohol was prepared into a film to obtain a polyvinyl alcohol film;

S4, polyurethane glue was sufficiently and evenly mixed with starch carrageenan to obtain waterborne composite glue;

S5, the above waterborne composite glue was coated on the polyvinyl alcohol film through the existing degradable high-barrier packaging coating equipment to form a barrier layer, wherein the coating densities of polyurethane glue and starch carrageenan were controlled to 2 g/m²;

S6, terephthalic acid-adipic acid-butanediol copolyester was prepared into a film and patterns were printed by a printing machine to obtain a terephthalic acid-adipic acid-butanediol copolyester film;

S7, the above terephthalic acid-adipic acid-butanediol copolyester film was composited with the polylactic acid film utilizing a solvent-free compositing machine through the barrier layer to form a degradable layer, then the degradable layer was cured for 72 h using a curing machine, and subsequently, the composition degree was inspected using an article test machine, so as to obtain the full biodegradable high-barrier multi-layer composite material; and

S8, polylactic acid and terephthalic acid-adipic acid-butanediol copolyester were mixed in a mass ratio of 5:5 and then prepared into a zipper; then the zipper and the above obtained full biodegradable high-barrier multi-layer composite material were made into a bag through a bag making machine, so as to obtain a packaging bag with a full biodegradable high-barrier multi-layer.

### Example 4

This example provides a full biodegradable high-barrier multi-layer composite material and a packaging bag, wherein a method for preparing the packaging bag comprises the following steps:

S1, 45 g of polylactic acid (PLA), 90 g of terephthalic acid-adipic acid-butanediol copolyester (PBAT), 45 g of polyvinyl alcohol (PVA), 45 g of polyurethane glue and 45 g of starch carrageenan were weighed; wherein, the polyurethane glue included an isocyanate prepolymer (A glue) and polyester polyol (B glue), a mass ratio of isocyanate prepolymer to polyester polyol was 100:75; a mass ratio of starch glue to carrageenan in the starch carrageenan was 5:5;

S2, the above weighed polylactic acid was biaxially stretched to obtain a polylactic acid film for later use;

S3, the above weighed polyvinyl alcohol was prepared into a film to obtain a polyvinyl alcohol film;

S4, polyurethane glue was sufficiently and evenly mixed with starch carrageenan to obtain waterborne composite glue;

S5, the above waterborne composite glue was coated on the polyvinyl alcohol film through the existing degradable high-barrier packaging coating equipment to form a barrier layer, wherein the coating densities of polyurethane glue and starch carrageenan were controlled to 4 g/m²;

S6, terephthalic acid-adipic acid-butanediol copolyester was prepared into a film and patterns were printed by a printing machine to obtain a terephthalic acid-adipic acid-butanediol copolyester film;

S7, the above terephthalic acid-adipic acid-butanediol copolyester film was composited with the polylactic acid film utilizing a solvent-free compositing machine through the barrier layer to form a degradable layer, then the degradable layer was cured for 72 h using a curing machine, and subsequently, the composition degree was inspected using an article test machine, so as to obtain the full biodegradable high-barrier multi-layer composite material; and

S8, polylactic acid and terephthalic acid-adipic acid-butanediol copolyester were mixed in a mass ratio of 5:5 and then prepared into a zipper; then the zipper and the above obtained full biodegradable high-barrier multi-layer composite material were made into a bag through a bag making machine, so as to obtain a packaging bag with a full biodegradable high-barrier multi-layer.

### Example 5

This example provides a full biodegradable high-barrier multi-layer composite material and a packaging bag, wherein a method for preparing the packaging bag comprises the following steps:

S1, 20 g of polylactic acid, 100 g of terephthalic acid-adipic acid-butanediol copolyester, 20 g of polyvinyl alcohol, 20 g of polyurethane glue and 40 g of starch carrageenan were weighed; wherein, the polyurethane glue included an isocyanate prepolymer (A glue) and polyester polyol (B glue), a mass ratio of isocyanate prepolymer to polyester polyol was 100:75; a mass ratio of starch glue to carrageenan in the starch carrageenan was 5:5;

S2, the above weighed polylactic acid was biaxially stretched to obtain a polylactic acid film for later use;

S3, the above weighed polyvinyl alcohol was prepared into a film to obtain a polyvinyl alcohol film;

S4, polyurethane glue was sufficiently and evenly mixed with starch carrageenan to obtain waterborne composite glue;

S5, the above waterborne composite glue was coated on the polyvinyl alcohol film through the existing degradable high-barrier packaging coating equipment to form a barrier layer, wherein the coating densities of polyurethane glue and starch carrageenan were controlled to 3 g/m²;

S6, terephthalic acid-adipic acid-butanediol copolyester was prepared into a film and patterns were printed by a printing machine to obtain a terephthalic acid-adipic acid-butanediol copolyester film;

S7, the above terephthalic acid-adipic acid-butanediol copolyester film was composited with the polylactic acid film utilizing a solvent-free compositing machine through the barrier layer to form a degradable layer, then the degradable layer was cured for 72 h using a curing machine, and subsequently, the composition degree was inspected using an article test machine, so as to obtain the full biodegradable high-barrier multi-layer composite material; and

S8, polylactic acid and terephthalic acid-adipic acid-butanediol copolyester were mixed in a mass ratio of 5:5 and then prepared into a zipper; then the zipper and the above obtained full biodegradable high-barrier multi-layer composite material were made into a bag through a bag making machine, so as to obtain a packaging bag with a full biodegradable high-barrier multi-layer.

### Example 6

This example provides a full biodegradable high-barrier multi-layer composite material and a packaging bag, wherein a method for preparing the packaging bag comprises the following steps:

S1, 40 g of polylactic acid, 80 g of terephthalic acid-adipic acid-butanediol copolyester, 40 g of polyvinyl alcohol, 40 g of polyurethane glue and 20 g of starch carrageenan were weighed; wherein, the polyurethane glue included an isocyanate prepolymer (A glue) and polyester polyol (B glue), a mass ratio of isocyanate prepolymer to polyester polyol was 100:75; a mass ratio of starch glue to carrageenan in the starch carrageenan was 5:5;

S2, the above weighed polylactic acid was biaxially stretched to obtain a polylactic acid film for later use;

S3, the above weighed polyvinyl alcohol was prepared into a film to obtain a polyvinyl alcohol film;

S4, polyurethane glue was sufficiently and evenly mixed with starch carrageenan to obtain waterborne composite glue;

S5, the above waterborne composite glue was coated on the polyvinyl alcohol film through the existing degradable high-barrier packaging coating equipment to form a barrier layer, wherein the coating densities of polyurethane glue and starch carrageenan were controlled to 3 g/m²;

S6, terephthalic acid-adipic acid-butanediol copolyester was prepared into a film and patterns were printed by a printing machine to obtain a terephthalic acid-adipic acid-butanediol copolyester film;

S7, the above terephthalic acid-adipic acid-butanediol copolyester film was composited with the polylactic acid film utilizing a solvent-free compositing machine through the barrier layer to form a degradable layer, then the degradable layer was cured for 72 h using a curing machine, and subsequently, the composition degree was inspected using an article test machine, so as to obtain the full biodegradable high-barrier multi-layer composite material; and

S8, polylactic acid and terephthalic acid-adipic acid-butanediol copolyester were mixed in a mass ratio of 5:5 and then prepared into a zipper; then the zipper and the above obtained full biodegradable high-barrier multi-layer composite material were made into a bag through a bag making machine, so as to obtain a packaging bag with a full biodegradable high-barrier multi-layer.

### Example 7

This example provides a full biodegradable high-barrier multi-layer composite material and a packaging bag, wherein a method for preparing the packaging bag comprises the following steps:

S1, 30 g of polylactic acid, 90 g of terephthalic acid-adipic acid-butanediol copolyester, 30 g of polyvinyl alcohol, 30 g of polyurethane glue and 30 g of starch carrageenan were weighed; wherein, the polyurethane glue included an isocyanate prepolymer (A glue) and polyester polyol (B glue), a mass ratio of isocyanate prepolymer to polyester polyol was 100:75; a mass ratio of starch glue to carrageenan in the starch carrageenan was 5:5;

S2, the above weighed polylactic acid was biaxially stretched to obtain a polylactic acid film for later use;

S3, the above weighed polyvinyl alcohol was prepared into a film to obtain a polyvinyl alcohol film;

S4, polyurethane glue was sufficiently and evenly mixed with starch carrageenan to obtain waterborne composite glue;

S5, the above waterborne composite glue was coated on the polyvinyl alcohol film through the existing degradable high-barrier packaging coating equipment to form a barrier layer, wherein the coating densities of polyurethane glue and starch carrageenan were controlled to 3 g/m²;

S6, terephthalic acid-adipic acid-butanediol copolyester was prepared into a film and patterns were printed by a printing machine to obtain a terephthalic acid-adipic acid-butanediol copolyester film;

S7, the above terephthalic acid-adipic acid-butanediol copolyester film was composited with the polylactic acid film utilizing a solvent-free compositing machine through the barrier layer to form a degradable layer, then the degradable layer was cured for 72 h using a curing machine, and subsequently, the composition degree was inspected using an article test machine, so as to obtain the full biodegradable high-barrier multi-layer composite material; and

S8, polylactic acid and terephthalic acid-adipic acid-butanediol copolyester were mixed in a mass ratio of 5:5 and then prepared into a zipper; then the zipper and the above obtained full biodegradable high-barrier multi-layer composite material were made into a bag through a bag making machine, so as to obtain a packaging bag with a full biodegradable high-barrier multi-layer.

The above full biodegradable high-barrier multi-layer composite material prepared in example 7 is subjected to oxygen permeation rate test, and test results are as shown in Table 1.

TABLE 1

| | Oxygen permeation rate |
|---|---|
| Test programs | (cc/m²/24 h/1 Pa/24° C.) |
| Example 7 | ≤35 |

It can be seen from Table 1 that the full biodegradable high-barrier multi-layer composite material provided by the examples of the present disclosure is obtained by using the terephthalic acid-adipic acid-butanediol copolyester as a degradable layer and using polyvinyl alcohol as a barrier layer and by composing the degradable layer with the barrier layer via polyurethane glue and starch carrageenan, and has the advantages of low oxygen permeation rate, good barrier property and good preservation degree.

Besides, it should be understood that although this specification is described according to the embodiments, not every embodiment only contains an independent technical solution. This description manner of the specification is only for the sake of clarity. Those skilled in the art should take the specification as a whole, and the technical solutions in embodiments can be properly combined to form other embodiments that can be understood by those skilled in the art.

What is claimed is:

1. A full biodegradable high-barrier multi-layer composite material, comprising the following components in parts by weight: 10˜50 parts of polylactic acid, 20˜100 parts of terephthalic acid-adipic acid-butanediol copolyester, 10˜50 parts of polyvinyl alcohol, 10˜50 parts of polyurethane glue and 10˜50 parts of starch carrageenan.

2. The full biodegradable high-barrier multi-layer composite material according to claim 1, comprising the following components in parts by weight: 20˜40 parts of polylactic acid, 80˜100 parts of terephthalic acid-adipic acid-butanediol copolyester, 20˜40 parts of polyvinyl alcohol, 20˜40 parts of polyurethane glue and 20˜40 parts of starch carrageenan.

3. The full biodegradable high-barrier multi-layer composite material according to claim 1, wherein the polyurethane glue comprises an isocyanate prepolymer and polyester polyol.

4. The full biodegradable high-barrier multi-layer composite material according to claim 3, wherein a mass ratio of the isocyanate prepolymer to the polyester polyol is 100: (70˜80).

5. The full biodegradable high-barrier multi-layer composite material according to claim 1, wherein a mass ratio of starch glue to carrageenan in the starch carrageenan is (4˜6): (6˜4).

6. A preparation method of a full biodegradable high-barrier multi-layer composite material according to claim 1, comprising the following steps:
weighing polylactic acid, a terephthalic acid-adipic acid-butanediol copolyester, polyvinyl alcohol, polyurethane glue and starch carrageenan according to the weight parts of the above components;
biaxially stretching polylactic acid to obtain a polylactic acid film;
preparing polyvinyl alcohol into a film to obtain a polyvinyl alcohol film;
mixing polyurethane glue with starch carrageenan to obtain waterborne composite glue;
coating the waterborne composite glue on the polyvinyl alcohol film to form a barrier layer;
preparing terephthalic acid-adipic acid-butanediol copolyester into a film to obtain a terephthalic acid-adipic acid-butanediol copolyester film; and
compositing the terephthalic acid-adipic acid-butanediol copolyester film with the polylactic acid film through the barrier layer, and then curing, so as to obtain the full biodegradable high-barrier multi-layer composite material.

7. A full biodegradable high-barrier multi-layer composite material prepared by the preparation method according to claim 6.

8. The full biodegradable high-barrier multi-layer composite material according claim 7, wherein the oxygen permeation rate of the full biodegradable high-barrier multi-layer composite material is no more than 35 cc/m²/24 h/1 Pa/24° C.

9. A packaging bag, comprising a bag body and a zipper, wherein the bag body is made of the full biodegradable high-barrier multi-layer composite material according to claim 1.

10. A packaging bag, comprising a bag body and a zipper, wherein the bag body is made of the full biodegradable high-barrier multi-layer composite material according to claim 2.

11. A packaging bag, comprising a bag body and a zipper, wherein the bag body is made of the full biodegradable high-barrier multi-layer composite material according to claim 3.

12. A packaging bag, comprising a bag body and a zipper, wherein the bag body is made of the full biodegradable high-barrier multi-layer composite material according to claim 4.

13. A packaging bag, comprising a bag body and a zipper, wherein the bag body is made of the full biodegradable high-barrier multi-layer composite material according to claim 5.

14. A packaging bag, comprising a bag body and a zipper, wherein the bag body is made of the full biodegradable high-barrier multi-layer composite material according to claim 7.

15. A packaging bag, comprising a bag body and a zipper, wherein the bag body is made of the full biodegradable high-barrier multi-layer composite material according to claim 8.

16. The packaging bag according to claim 9, wherein the zipper comprises polylactic acid and terephthalic acid-adipic acid-butanediol copolyester, and a mass ratio of polylactic acid to terephthalic acid-adipic acid-butanediol copolyester in the zipper is (4˜6):(6˜4).
